(19) United States
(12) Patent Application Publication
(10) Pub. No.: US 2020/0165405 A1
(43) Pub. Date: May 28, 2020

(54) POLYMERIC CRYSTALLINE COMPOSITION, METHOD OF MANUFACTURING SAME AND USES THEREOF

(71) Applicant: Ariel Scientific Innovations Ltd., Ariel (IL)

(72) Inventor: Theodor STERN, Jerusalem (IL)

(73) Assignee: Ariel Scientific Innovations Ltd., Ariel (IL)

(21) Appl. No.: 16/636,943

(22) PCT Filed: Aug. 6, 2018
(86) PCT No.: PCT/IL2018/050866

§ 371 Date: Feb. 6, 2020

Related U.S. Application Data
(60) Provisional application No. 62/541,728, filed on Aug. 6, 2017.

(51) Int. Cl. C08J 9/26

(52) U.S. Cl. CPC C08J 9/26; C08J 2201/044; C08J 2491/02; C08J 2323/06

(57) ABSTRACT

A composition comprising, a polymeric crystalline structure having lamellae and/or multilamellar structures and being devoid of trace of amorphous material, detectable by Scanning Electron Microscopy (SEM) with a magnification of ×2,300 at working distance of 10 mm and acceleration voltage of 15 kV.

### FIELD AND BACKGROUND OF THE INVENTION

The present invention, in some embodiments thereof, relates to polymeric materials and, more particularly, but not exclusively, to polymeric crystalline structures, methods of fabricating same and applications utilizing thereof.

Polymeric materials exhibit a wide variety of properties and applications, and meet the requirements for many applications.

Polymers typically crystallize in crystalline structure units termed lamellae, often forming multi-lamellar structures, or branched multi-lamellar structures, dendritic structures, or hierarchical multi-lamellar structures. The multi-lamellar structures can assume a wide variety of morphologies, but are often characterized by a quasi-radial symmetry and are thus referred to, as for example, spherulites, axialites, or sheaf structures. The individual lamellae and the constituent lamellae of the multi-lamellar structures can be of varying lengths, widths and spatial configurations. The thickness of each individual lamella may be in nano-scale, and in which case the individual lamella is referred to as a nano-lamella.

Nano-lamellae are formed by polymeric chain-folding crystallization mechanism, which typically occurs in the direction perpendicular to the axial direction of the lamellae.

In conventional crystallization techniques applied to crystallizable polymers, the crystallization is not complete, due to the presence of non-crystallizable fractions of the polymer, originating from, for example, polydispersity; chain folds; chain entanglements and/or inter-segmental interference [1-6]. As a result, the polymers, even though termed “crystallizable polymers” become only partially crystalline. The non-crystallizable fractions are excluded during crystalline growth and accumulate around the crystals and within the inter-lamellar gaps, forming the amorphous phase of the polymer. The relative amount of non-crystallizable fractions, depends on the polymer type, its degree of purity, average molecular weight, molecular weight distribution, branching, chain entanglements, chain folds, etc.

Known are etching techniques that are capable of partially removing polymeric amorphous phase. These include etching with acid, permanganate, electron beam bombardment, ion beam bombardment and plasma [7-12].

### SUMMARY OF THE INVENTION

According to some embodiments of the present invention there is provided a composition. The composition comprises, a polymeric crystalline structure having lamellae and/or multilamellar structures and being devoid of trace of amorphous material, detectable by Scanning Electron Microscopy (SEM) with a magnification of ×2,300 at working distance of 10 mm and acceleration voltage of 15 kV.

According to some embodiments, at least a portion of the multilamellar structures form a bundle of lamellar nanostructures.

According to an aspect of some embodiments of the present invention there is provided a composition. The composition comprises, a polymeric crystalline structure having lamellae and/or multilamellar structures and being devoid of trace of amorphous material, detectable by Scanning Electron Microscopy (SEM) with a magnification of ×2,300 at working distance of 10 mm and acceleration voltage of 15 kV.

According to an aspect of some embodiments of the present invention there is provided a composition. The composition comprises, a polymeric crystalline structure having lamellae and/or bundles of lamellar structures and being devoid of trace of amorphous material, wherein each of the lamellae and/or multilamellar structures is devoid of etched edges detectable by Scanning Electron Microscopy (SEM) with a magnification of ×2,300 at working distance of 10 mm and acceleration voltage of 15 kV.

According to an aspect of some embodiments of the present invention there is provided a composition. The composition comprises, crystalline structure having a bundle of lamellar nanostructures comprising a polymer, wherein each of the lamellar nanostructures in the bundle is devoid of etched edges detectable by Scanning Electron Microscopy (SEM) with a magnification of ×2,300 at working distance of 10 mm and acceleration voltage of 15 kV.

According to an aspect of some embodiments of the present invention there is provided a composition. The composition comprises, a crystalline structure having a plurality of bundles of lamellar nanostructures comprising a polymer, wherein a first side of the crystalline structure engages a substrate and a second side of the crystalline structure is free, wherein inter-bundle voids at the second side, over an area of about 10 square μm and thickness of about 1 μm, have an average diameter of at least 1 μm, and are devoid of any amorphous material.

According to an aspect of some embodiments of the present invention there is provided a composition. The composition comprises, a polymeric crystalline structure having a plurality of lamellae or multi-lamellar structures comprising a polymer, wherein a first side of the crystalline structure engages a substrate and a second side of the crystalline structure is free, wherein inter-lamellar or inter-multi-lamellar voids at the second side, over an area of about 10 square μm and thickness of at least 1 μm, have an average (equivalent) diameter of at least 0.01 μm, and are devoid of any amorphous material.

According to an aspect of some embodiments of the present invention there is provided a composition. The composition comprises, a crystalline structure having a first plurality of bundles of lamellar nanostructures comprising a polymer arranged on a substrate generally perpendicular thereto, and at least one additional bundle of lamellar nanostructure generally parallel to the substrate and being on top of lamellar nanostructures of the first plurality and/or sequences and/or multiple layers thereof.

According to some embodiments of the invention, the substrate and the crystalline structure comprise the same polymer.

According to some embodiments of the invention, the composition further comprising a foreign material that is generally different from the polymeric material, the foreign material at least partially filling at least one void between at least two lamellae or bundles of lamellar nanostructures or at least partially coating surfaces thereof.

According to some embodiments of the invention the bundle of lamellar structures has a structure selected from the group consisting of: a multi-lamellar structure, nano-lamellar structure, branched lamellae structure, branched multi-lamellar structure, twinned lamellar structure, spherulite structure, sheaf-structure, axialite structure, dendritic spherulite structure, dendritic structure, interconnecting ordered lamellae structure, interconnecting disordered lamellae structure, epitaxial grown lamellae and any combination thereof.

According to some embodiments of the invention, the composition wherein a surface region of at least one lamella, separate from the bundle and/or in the bundle of lamellar structures is devoid of amorphous material.

According to some embodiments of the invention, at least 25% of the surface area of each of at least 10 of the lamellae, is devoid of amorphous material.

According to some embodiments of the invention, at least 5 of the lamellae and/or the lamellar structures have two opposing surfaces comprising a first surface and a second surface and a thickness therebetween, the average of the thickness being smaller than an average width of the two surfaces.

According to some embodiments of the invention, the lamellae and/or the lamellar structures comprise quantum dots and/or are unidimensional.

According to some embodiments of the invention, the composition comprises lamellae and/or lamellar structures having neighboring lamellae associated in at least one point.

According to some embodiments of the invention, the lamellae and/or lamellar structures having average thickness less than 1 μm.

According to some embodiments of the invention, the composition has voids at least partially separate at least 2 crystalline lamellae and/or crystalline multi-lamellar structures or combinations thereof, the voids having a diameter of at least 0.01 μm.

According to some embodiments of the invention, the voids are present at least over an area of about 10 square μm and thickness of about 1 μm, have an average diameter of at least about 0.01 μm, and are devoid of any amorphous material.

According to some embodiments of the invention, inter-bundle voids at the second side, over an area of about 10 square μm and thickness of about 1 μm, have an average diameter of at least about 0.1 μm, and are devoid of any amorphous material.

According to some embodiments of the invention, inter-lamellar or inter-multi-lamellar voids at the second side, over an area of about 10 square μm and thickness of at least 1 μm, have an average diameter of at least 0.01 μm, and are devoid of any amorphous material. According to some embodiments of the invention, at least two of the voids are interconnected.

According to some embodiments of the invention, the polymer is selected from: a thermoplastic polymer, a copolymer, a block-copolymer, a homopolymer, an oligomer, a branched polymer, a grafted polymer, a synthetic polymer, a natural polymer, a modified natural polymer, a denaturated natural polymer, degradation-derived fractions of a natural and/or a synthetic polymer, a degradable polymer, a polymer with chemically and/or physically bonded active agent/molecule and/or drug, a polymer with chemically and/or physically bonded electrically, catalytically and/or optically active molecule and/or atom and combinations thereof.

According to some embodiments of the invention, the polymer is selected from: a polyester, a polyamide, a polypeptide, a polyimide, a polyether, a polyolefin, an unsaturated polyolefin, a polysulfone, a polysaccharide, an acrylic polymer, a polysiloxane, a polyanhydride, a polyurethane, a polyurea, a poly(ether urethane), a poly(ether urethane amide), a poly(ester urethane), a poly(ether urethane urea) and combinations thereof.

According to some embodiments of the invention, the polymer comprises a blend of at least two polymers.

According to some embodiments of the invention, the blend of at least two polymers is phase-separated.

According to some embodiments of the invention, the polymer comprises HDPE.

According to some embodiments of the invention, the polymer is part of a composite material.

According to some embodiments of the invention, the composition having a degree of crystallinity of at least about 1%.

According to an aspect of some embodiments of the present invention there is provided a polymeric article comprising the composition described herein, wherein in at least 1% of at least one of the polymeric article's dimensions selected from length, width, height, thickness, depth, diameter, radius, weight, volume and surface area.

According to some embodiments of the invention, the composition serving as a component in an object selected from: a microelectronic device, a space replica, an artificial implant, an artificial tissue, a controlled delivery system, a medicament, a biofilm, a membrane, a filter, a chromatography column, a size-exclusion column, an ion exchange column, a catalyst, a nano-scaffold, a micro-robot, a micro-machine, a nano-machine, a processor, an optical device, a molecular sieve, a detector, an adsorbing material, a substrate, a nucleant, a nano-reactor, a mechanical component, a friction coefficient reducer or enhancer, and a gecko foot simulator.

According to some embodiments of the invention, at least one surface region of the composition is coated with a material.

According to some embodiments of the invention, the composition further comprises at least one nucleant.

According to an aspect of some embodiments of the present invention there is provided a method of producing a crystalline polymer material. The method comprises providing a molten polymer; determining at least one property of a final polymer material in molten state selected from the group consisting of: size, shape and thickness; initiating crystallization of polymer crystals in a molten polymer; rendering growth of polymer crystals in the molten polymer; during the crystallization, immersing the polymer crystals and the molten polymer in an extracting solvent; removing the polymer from the solvent; and removing residual adsorbed solvent from the polymer crystals after the removal of the polymer from the solvent; thereby producing a final crystalline polymer material that is essentially free of amorphous material.

According to an aspect of some embodiments of the present invention there is provided a method of producing a crystalline polymer material. The method comprises initiating growth of polymer crystals from a molten polymer; during the growth, immersing the polymer crystals and the molten polymer in an extracting solvent; removing at least one polymer crystals from the solvent; and removing residual adsorbed solvent from the polymer crystals; thereby producing a final crystalline polymer material that is essentially free of amorphous material.

According to an aspect of some embodiments of the present invention there is provided a method of producing a crystalline polymer material. The method comprises melting a polymer; determining at least one property of a final polymer material in molten state selected from the group consisting of: size, shape and thickness; initiating growth of polymer crystals in the molten polymer; during the growth, immersing the polymer crystals and the molten polymer in a solvent, under chosen conditions selected from: solvent temperature, agitation and immersion time; removing the immersed polymer crystals from the solvent; and removing residual adsorbed solvent from the polymer crystals.

According to some embodiments of the invention, the immersing the polymer crystals and the molten polymer in a solvent is carried out at a solvent temperature of between −15° C. to 5° C. below solvent boiling point, agitation time of between 1 second to a time equal to the immersion time and immersion time of between 1 second to 600 seconds.

According to some embodiments of the invention, the method further comprises heating a polymer to provide the molten polymer, wherein the heating is executed prior to the initiation of the growth.

According to some embodiments of the invention, the removal of the polymer from the solvent is initiated prior to when the polymer crystal growth ends.

According to some embodiments of the invention, the crystallization is an isothermal process.

According to some embodiments of the invention, the heating is for duration and at a temperature selected to erase crystalline memory of the molten polymer prior to the initiation of crystallization.

According to some embodiments of the invention, the method further comprises cooling the molten polymer to provide the polymer crystals.

According to some embodiments of the invention, the cooling is carried out at an isothermal temperature.

According to some embodiments of the invention, the method further comprises any combination of continuous cooling and isothermal processes and/or consecutive repetition thereof, to provide the polymer crystals.

According to some embodiments of the invention, the crystallization is characterized by: a crystallization start time, defined as a time when a first polymer crystal is nucleated in the polymer melt; a crystallization end time, defined as characterized by a time when a last crystal stops growing in the melt and no additional crystals are formed; and a crystallization kinetics period tₖ, defined as a duration beginning at the crystallization start time and ending at the crystallization end time, and wherein the immersing is executed at a time of between about 0.01 tₖ and about 0.99 tₖ after the crystallization start time.

According to some embodiments of the invention, the method further comprises receiving at least one of the crystallization start time, crystallization end time, and crystallization kinetics period tₖ as input.

According to some embodiments of the invention, the immersing is executed after at least about 0.01% of the molten polymer becomes crystals.

According to some embodiments of the invention, the method further comprises mixing the molten polymer with at least one amorphous additive material prior to the crystallization start time.

According to some embodiments of the invention, the method further comprises further comprising mixing the molten polymer with at least one additive material that has at least one of the following properties: it is amorphous; it is liquid at melting temperature of the polymer; it does not crystallize when in mixture with the polymer; and it is not capable of phase-separating from the polymer melt prior to the immersing.

According to some embodiments of the method of the invention, the at least one additive material is selected from: low-molecular-weight synthetic polymers, low-molecular-weight natural polymers, fractioned polymers, branched polymers, dendrimers, essential oils, paraffin oils, oligomers, oils, non-volatile organic compounds, non-volatile solvents, surfactants, detergents, slip agents, organic dyes, plasticizers, phthalates, wetting agents and combinations thereof.

According to some embodiments of the method of the invention, the at least one amorphous additive material is and/or comprises at least one of a surfactant and/or a wetting agent.

According to some embodiments of the method of the invention, the polymer is a crystallizable polymer.

According to some embodiments of the method of the invention, the polymer comprises at least one of a thermoplastic polymer, a copolymer, a block-copolymer, a homopolymer, an oligomer, a branched polymer, a grafted polymer a branched polymer a grafted polymer. a synthetic polymer, a natural polymer, a modified natural polymer, a denaturated natural polymer, a degradation-derived fraction of a natural or a synthetic polymer, a degradable polymer, a polymer with a chemically or a physically bonded active agent/molecule or drug, a polymer with chemically or physically bonded electrically, catalytically or an optically active molecule or an atom and combinations thereof.

According to some embodiments of the method of the invention, the polymer comprises a blend of at least two polymers.

According to some embodiments of the method of the invention, the blend of at least two polymers is phase-separated.

According to some embodiments of the method of the invention, the polymer comprises HDPE.

According to some embodiments of the method of the invention, the polymer is selected from: a polyester, a polyamide, a polypeptide, a polyimide, a polyether, a polyolefin, an unsaturated polyolefin, a polysulfone, a polysaccharide, an acrylic polymer, a polysiloxane, a polyanhydride, a polyurethane, a polyurea, a polyether urethane, a polyether urethane amide, a polyester urethane, a polyether urethane urea and combinations thereof.

According to some embodiments of the invention, the method further comprises heating the molten polymer while mixing with a sufficient amount of at least one amorphous material to obtain a homogeneous slurry before the cooling.

According to some embodiments of the invention, the method further comprises applying on a surface of a support, a layer of the homogeneous slurry.

According to some embodiments of the invention, the method further comprises forming a film of the molten polymer after the mixing the molten polymer with a sufficient amount of at least one amorphous material.

According to some embodiments of the invention, the method further comprises applying a continuous processing while determining at least one property of a final polymer material in molten state.

According to some embodiments of the invention, the continuous processing is by an extruder.

According to some embodiments of the invention, the immersing of the polymer crystals and the molten polymer in the extracting solvent is carried out at or below ambient temperature.

According to some embodiments of the invention, the immersing is carried out at or below 40° C.

According to some embodiments of the invention, the crystallization process is isothermal, and/or comprises an isothermal process, and/or is carried out to the full extent of the crystallization kinetics period, tₖ.

According to some embodiments of the invention, the crystallization process is carried out to the full extent of the crystallization kinetics period, tₖ.

According to some embodiments of the invention, the immersing of the polymer crystals in the extracting solvent is during a time period of from about 1 to about 300 seconds.

According to some embodiments of the invention, the immersing of the polymer crystals in the extracting solvent is during a time period of at least 2 seconds.

According to some embodiments of the invention, the method further comprises monitoring a transparency level of the polymer crystals and the molten polymer during the crystallization, ≤tₖ, wherein immersion is executed when the monitored transparency level equals or is below a predetermined threshold.

According to some embodiments of the invention, at least one surface region of the composition described herein is chemically reacted with a material selected from the group consisting of: a solid material, a liquid material, a gas, a molecule, an atom, or combinations thereof.

According to an aspect of some embodiments of the present invention there is provided a replica, or negative-space replica comprising the crystalline polymer material described herein. According to an aspect of some embodiments of the present invention there is provided a replica, or negative-space replica resembling the crystalline polymer material described herein.

According to an aspect of some embodiments of the present invention there is provided a crystalline polymer material manufactured by the method described herein.

According to an aspect of some embodiments of the present invention there is provided use of the amorphous material extracted according to the method described herein as a lubricant; a slip agent; a plasticizer; a pharmaceutical excipient; a wetting agent; a surfactant; an additive; a material with mild mechanical and thermal properties; a food additive; a reagent; a coating; a carrier for pigments; a carrier for active molecules; a surgical injectable material; a thickening agent; a diluting agent; a solvent; a fuel component; a cosmetic material and a gel. Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A and 1B are scanning electron microscopy (SEM) images of high-density polyethylene (HDPE) polymer;

FIG. 2 is a schematic illustration of a method suitable for preparing a crystalline composition, according to some embodiments of the present invention;

FIG. 3 is a SEM image of HDPE polymer, as obtained in experiments performed according to some embodiments of the present invention;

FIG. 4 shows overlaid comparison of Fourier-Transformed Infrared (FTIR) spectra of HDPE polymer (upper spectrum) and of paraffin oil additive (lower spectrum) utilized according to some embodiments of the present invention;

FIG. 5 is a schematic illustration of another method suitable for preparing a crystalline composition, according to embodiments of the present invention in which at least one additive is utilized;

FIGS. 6A and 6B are SEM images of HDPE polymer, produced by the method shown in FIG. 5; and

FIG. 7 shows a comparison of X-Ray Diffraction (XRD) graphs of exemplary polymers, according to some embodiments of the present invention, in which 0% w/w (upper graph), 30% w/w (middle graph) and 50% w/w (lower graph) additive was utilized.

### DESCRIPTION OF SPECIFIC EMBODIMENTS OF THE INVENTION

The present invention, in some embodiments thereof, relates to polymeric materials and, more particularly, but not exclusively, to polymeric crystalline structures, methods of fabricating same and applications utilizing thereof.

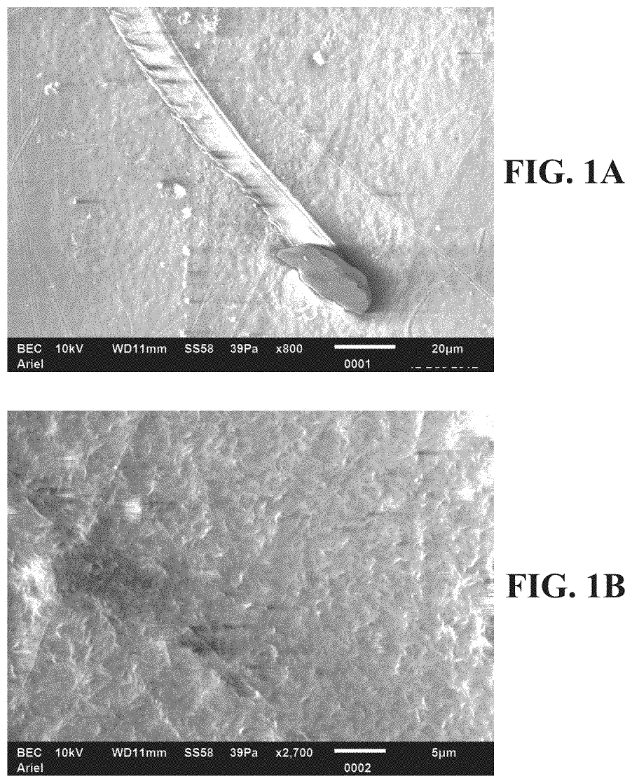

For purposes of better understanding some embodiments of the present invention, reference is first made to a polymeric material, as illustrated in FIGS. 1A-1B, exhibiting Scanning Electron Microscopy (SEM) images of a HDPE film according to Comparative Example 1, described below, at magnifications of ×800 and ×2,700, respectively. FIGS. 1A-1B visually display amorphous non-crystallized material. Rhythmic changes in surface topography, is an indication of crystalline morphology within the amorphous phase, which is not only on the surface, but also throughout material enveloping all crystalline lamellae. As both crystalline nano-lamellae and interpenetrating amorphous phase are composed of the same polymer, the very slight physical differences between them do not enable significant selective removal of the amorphous phase, without significantly destroying the nano-lamellar super-structures.

The present Inventor devised a technique that allows fabricating improved polymeric crystals with a reduced amount of, more preferably devoid of, amorphous phase.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Preferred embodiments of the present invention provide polymeric crystalline compositions, preferably, comprising crystalline lamellar structures and/or multi-lamellar structures and/or nano-lamellar structures. Such structures may be free-standing and/or unidimensional, for example, having at least one dimension (length, width, thickness) in nanoscale, and may optionally and preferably include a bundle of plurality of such crystalline structures. Preferred embodiments of the invention also provide methods of making such polymeric crystalline compositions. Some embodiments employ non-destructive selective methods for producing polymeric crystalline compositions having desired properties, such as: shape, size, morphology, crystallinity percentage and orientation of structures therein. Preferred embodiments of the present invention provide uses and applications of such polymeric crystalline compositions. Preferred embodiments of the present invention provide uses and applications of extracted amorphous polymeric compounds resulting as a by-product of the methods described herein.

The polymeric crystalline compositions of the present embodiments may be single crystalline. The composition may be at least 80% free, preferably, at least 85% free, or at least 90% free, more preferably at least 95%, yet more preferably at least 96%, or 97%, or 98%, or 99%, or even 99.5% free of amorphous materials and/or of impurities. The polymeric crystalline compositions may optionally and preferably be essentially free of amorphous material and/or impurities detectable by an appropriate experimental technique, such as one or more of the following experimental techniques: Scanning Electron Microscopy (SEM), X-Ray Diffraction (XRD), Thermal Gravimetric Analysis (TGA), Transmission Electron Microscopy (TEM) and/or any technique known in the art of polymers and/or nano-science for determining the degree of crystallinity of a polymer. Examples of impurities may include materials other than the polymer comprising the polymeric composition.

The polymer may be any suitable polymer known in the art, for example a polymer selected from: a thermoplastic polymer, a copolymer, a block-copolymer, a homopolymer, an oligomer, a branched polymer a grafted polymer, a synthetic polymer, a natural polymer, a modified natural polymer, a denaturated natural polymer, a degradable polymer, degradation-derived fractions of a natural and/or a synthetic polymer, a degradable polymer, a polymer with chemically and/or physically bonded active agent/molecule and/or drug, a polymer with chemically and/or physically bonded electrically, catalytically and/or optically active molecule and/or atom, a polyester, a polyamide, a polypeptide, a polyimide, a polyether, a polyolefin, an unsaturated polyolefin, a polysulfone, a polysaccharide, an acrylic polymer, a polysiloxane, a polyanhydride, a polyurethane, a polyurea, a poly(ether urethane), a poly(ether urethane amide), a poly(ester urethane), a poly(ether urethane urea), and combinations thereof. The polymer may comprise a single polymer and/or may comprise a blend of at least two polymers, preferably, but not necessarily, from the polymers described above. In such embodiments, the blend of at least two polymers may be phase-separated.

The polymer for providing the composition according to some embodiments of the present invention may be any crystallizeable polymer.

As used herein “crystallizeable polymer” refers to any polymer that can be transformed, from a liquid state to a solid state to provide a solid that contains at least one crystal.

The degree of crystallinity of a material that, when in solid state, contains at least one crystal, is expressed herein in percentage and describes the ratio between the weight of molecules that constitute a crystalline phase of the material and the total weight of molecules of the material.

The term “crystalline phase”, as used herein, refers to polymer chains that possess structural order.

The term “structural order”, as used herein, refers to an alignment of polymer chains in a lattice in a periodic manner.

The degree (% percent) of crystallinity of the polymer composition provided herein ranges from about 1% to about 99.5%, or at times from about 20% to about 99.5%, from about 80% to about 99.5%. In some embodiments, the degree of crystallinity of the polymeric composition is at least about 1%, or at least about 5%, or at least about 10%, or at least about 30%, or at least about 40%, or at least about 60%, or at least about 70%, or at least about 80%, or at least about 90%, or at least about 92%, or at least about 94%, or at least about 95%, or at least about 96%, or at least about 97%, or at least about 98%, or at least about 99%, or even at times, at least about 99.5%.

In some exemplary embodiments described herein the polymer comprises HDPE.

As used herein, “composite material” refers to a material having at least two distinct constituent phases, having an interface therebetween: (i) a matrix as a continuous phase, and (ii) at least one discontinuous phase dispersed within the continuous phase, in a manner that the continuous phase surrounds or partially surrounds the discontinuous phase.

The continuous and discontinuous phases are typically made of different materials. Typically, the discontinuous phase enhances physical properties of the matrix.

The composition according to some embodiments of the present invention may be a composite material having at least one continuous phase (e.g., polymer) and at least one discontinuous phase (e.g., reinforcement material, such as fibers). The composition of the present embodiments may comprise at least one surface region coated with a coating material. In some embodiments, the polymeric composition described herein is at least partially coated with another material. Some non-limiting examples of such coating materials are: a conductive material, a semi-conductive material, an insulating material, a metal, metal alloys, a metal oxide, a salt, a catalyst, a drug, an enzyme, an optically active material, a biofilm, a gel, a sol-gel, a polymer, and any combinations thereof.

The composition may further comprise at least one nucleant, which may be present in the final product, and may include any type of crystalline material and/or combination of crystalline materials, such as, but not limited to, organic, inorganic, polymeric, or non-polymeric. The nucleant can be of any type and of any shape and size.

The polymeric crystalline composition may comprise structures having at least one dimension (length, width, thickness) in the nanoscale. The structures may optionally be zero-dimensional, for example, quantum dots; and/or may optionally be unidimensional, for example nano-wires or nano-rods; and/or may optionally be two-dimensional, for example, nano-films.

As used herein “dimension in the nanoscale” means a dimension which is at least 1 nm and less than 1 μm.

A quantum dot, as used herein, is a crystalline structure with size dependent optical and electrical properties. Specifically, a quantum dot exhibits quantum confinement effects such that there is a three-dimensional confinement of electron-hole bound pairs or free electrons and holes. The crystalline structure can have any shape. Preferably, the largest cross-sectional dimension of such structure is of less than about 15 nanometers, e.g., from about 0.2 nanometers to about 10 nanometers.

As used herein “multi-lamellar structure” refers to a polymeric crystalline structure comprising at least two lamellae in contact or interaction (e.g., in crystallographic relation or by epitaxial growth interaction). Such structures include, spherulitic and sheaf structures.

In some exemplary embodiments according to the present invention, the diameter of the structure(s) may be between about 100 nm and about 10 cm. Shapes and sizes of lamellae may be varied for various polymers and processing conditions, even within the same spherulite. For example, for HDPE polymer the spherulite diameter may vary from about 3 μm to about 300 μm.

As such, the crystals according to some embodiments of present invention are not limited to size and shape of the crystals and it may be possible to obtain any polymeric crystalline form, size, shape and/or dimensions.

In some exemplary embodiments of the present invention, the polymeric composition may comprise a plurality of crystalline structures, in some embodiments of the present invention the polymeric composition comprises nano-lamellar structures and in some embodiments of the present invention the polymeric composition comprises multi-lamellar structures. The crystalline structures may optionally and preferably be organized in a sheaf structure and/or spherulite structure and/or may comprise sheaf and/or spherulite structure.

As used herein “sheaf structure” refers to a structure and/or super-structure formed by crystal splitting during growth of a crystal along a certain facet crystalline orientation to provide hay-stack or straw bundles (bunch of straws) form of nano-lamellar structures.

As used herein, “super-structure(s)” refers to an extension of existing lamellar structures imposed above a baseline plane of essentially similar lamellar structures. Sheaf super-structure(s) may be oriented at 90° to the plane of the same structures beneath (e.g., parallel to the substrate), when optically (visually) observed by a suitable characterization technique for determining crystalline materials structure, such as SEM and TEM.

The sheaf structures according to some embodiments of the present invention have lamellar crystalline structures and/or super-structures oriented essentially in the same direction (e.g., in vertical direction), namely, the nano-lamellar super-structures may have a consistent ordered preferential orientation with respect to the plane of the substrate (with tolerance of at most 5°). The lamellar crystalline super-structures may have and/or may comprise nano-lamellar and/or multi-lamellar structures.

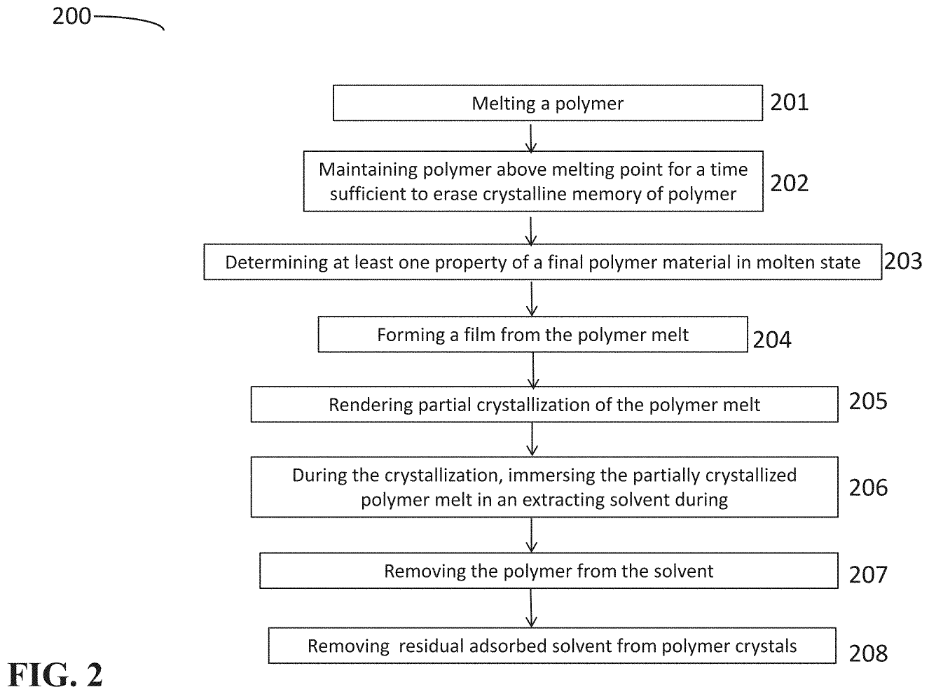

For purposes of better understanding some embodiments of the present invention, reference is now made to FIGS. 2-7 of the drawings.

An exemplary system for producing the polymeric composition, according to some embodiments of the present invention, generally includes a heating source, e.g., a heating and magnetic stirring plate and/or an oven, immersion bath, a thermometer and/or thermocouple, inert mixing or forming utensils (such as glass rods), microscope glass slides, and a chemical hood suitable for working with solvents.

FIG. 2 is a flowchart diagram of a method suitable for preparing a crystalline polymeric composition, according to various exemplary embodiments of the present invention. The method is referred to herein as method 200.

It is to be understood that, unless otherwise defined, the operations described hereinbelow can be executed either contemporaneously or sequentially in many combinations or orders of execution. Specifically, the ordering of the flowchart diagrams is not to be considered as limiting. For example, two or more operations, appearing in the following description or in the flowchart diagrams in a particular order, can be executed in a different order (e.g., a reverse order) or substantially contemporaneously. Additionally, several operations described below are optional and may not be executed.

At 201 a measured amount of a semi-crystalline polymer is melted, e.g., on a glass slide by using a controlled-temperature heating plate, preferably at above melting temperature. Some non-limiting examples of polymers that may be utilized according to the method of the present embodiments are: a thermoplastic polymer, a copolymer, a block-copolymer, a homopolymer, an oligomer, a branched polymer a grafted polymer, a synthetic polymer, a natural polymer, a modified natural polymer, a denaturated natural polymer, degradation-derived fractions of a natural and/or a synthetic polymer, a degradable polymer, a polymer with chemically and/or physically bonded active agent/molecule and/or drug, a polymer with chemically and/or physically bonded electrically, catalytically and/or optically active molecule and/or atom, a polyester, a polyamide, a polypeptide, a polyimide, a polyether, a polyolefin, an unsaturated polyolefin, a polysulfone, a polysaccharide, an acrylic polymer, a polysiloxane, a polyanhydride, a polyurethane, a polyurea, a poly(ether urethane), a poly(ether urethane amide), a poly(ester urethane), a poly(ether urethane urea), and combinations thereof. The polymer may comprise a single polymer and/or may comprise a blend of at least two polymers, preferably from the polymers described above. In such embodiments, the blend of at least two polymers may be phase-separated. In some exemplary embodiments, the method wherein the polymer comprises HDPE.

At 202 the polymer is optionally and preferably maintained above its melting point for a time sufficient to erase crystalline memory of the polymer. For example, in tests in which HDPE polymer was utilized according to some embodiments of the present invention, the polymer melt was heated to a temperature of 150° C. and maintained above this temperature for about 2 min.

At 203, at least one property selected from: size, shape and thickness of the final polymeric product is optionally and preferably determined, e.g., by industrial processing method such as, but not limited to, extrusion; calendering; casting; blowing; molding; compression molding; spinning; melt spinning; spraying; coating; expanding; foaming; rotation molding; injection molding; ram molding; reaction injection molding; production of mono-oriented and/or bi-oriented films or sheets.

In an industrial process, especially in a continuous process, a supporting substrate may not be needed unless the substrate constitutes a processing advantage, by performing extraction through both sides of the polymer sample, pertaining to both efficiency of total end product production.

At 204 the polymer is optionally shaped, for example, manually, to form a film of the polymer on a slide (e.g., a glass slide). This can be done, for example, by utilizing a cylindrical rod (e.g., glass rod) placed on a heating source. At 205 partial crystallization of the polymer melt is allowed. This can be achieved under any chosen conditions, e.g., by air-cooling the molten polymer at room temperature (about 30° C.) to provide polymer crystals. The cooling may be carried out at an isothermal temperature, depending on the polymer type, and quality and desired end product properties.

The slide supporting the polymer may be removed from the heating source.

In various exemplary embodiments of the invention the following parameters are defined:

Crystallization initiation of the polymer melt, defined as a time point at which a first polymer crystal is nucleated in the polymer melt (which time point is referred to herein as: “Crystallization Start Time”).

End of crystallization process, defined as a time when a last crystal stops growing in the melt and no additional crystals are formed (also referred to herein as: “Crystallization End Time”).

The crystallization may be carried out by any process or combination of processes selected from isothermal process, continuous cooling and/or consecutive repetition thereof, to provide the polymer crystals. “Crystallization Kinetics Period”, tₖ, is defined as duration beginning at the crystallization start time and ending at the crystallization end time.

At a selected time point during the crystallization process 205, the partially crystallized polymer melt may be immersed 206 (for example, along with the slide) in a suitable extracting solvent, such as, but not limited to, xylene (analytical grade, Frutarom), under conditions (e.g., solvent temperature, agitation and immersion time) selected so as to efficiently and selectively remove the amorphous phase, without damaging the crystals formed during the partial crystallization process.

The immersing 206 may be initiated at any time point between about 0.01 tₖ and about 0.99 tₖ after said crystallization initiating. As such, the immersion may be performed at any time during tₖ but less than tₖ, thus, the initiation of the amorphous phase extraction is while the amorphous phase is still in hot melt state. In various exemplary embodiments of the invention the immersing is initiated after at least about 0.01%, preferably, at least about 20%, of the molten polymer becomes crystals.

The method according to some embodiments of the present invention substantially enhances the physical differences between the crystalline lamellae and the amorphous phase. Some examples of such physical differences are: free volume, solubility, density, molecular motion, inter-molecular and intra-molecular physical bonds, chain spatial configuration, viscosity, liquid state of the amorphous phase versus solid state of the crystals, and facilitates the selective extraction of the amorphous phase, and being non-destructive to the crystalline lamellae, by immersion of the partially crystallized polymer melt product into a suitable solvent according to the polymer type, under chosen conditions and extraction of the remaining hot melt.

For example, immersing the polymer crystals and the molten polymer in a solvent may be carried out at a solvent temperature of between −15° C. to 5° C. below solvent boiling point, agitation time of between 1 second to a time equal to the immersion time and immersion time of between 1 second to 600 seconds.

Optionally and preferably, the immersion is carried out under mild manual agitation, for a chosen period of time, for example, from about 1 second to about and 300 seconds, preferably from about 10 seconds to about 100 seconds, more preferably from about 20 seconds to about 40 seconds. In some exemplary experiments, the solvent may be cooled to a temperature of about 0° C., for example, in an ice-water bath, prior to the removing polymer from solvent (extracting) process, so as to enhance the solvent's selectivity towards only the polymer melt.

At 207 the polymer crystals, and optionally and preferably, also the slide may be removed from the extracting solvent after a chosen time period.

The extraction is preferably initiated prior to the end of the polymer crystals growth process (tₖ).

At 208, residual adsorbed solvent may be removed from the obtained polymer crystals, e.g., by immediately (for example, within less than about 5 seconds) contacting the polymer crystals with a drying device, such as, but not limited to, a blotting paper or the like. This step is advantageous since it prevents reprecipitation of extracted polymer from the solvent to adhere to the sample. The method of the present embodiments thus provides a final crystalline polymer material that is essentially free of amorphous material.

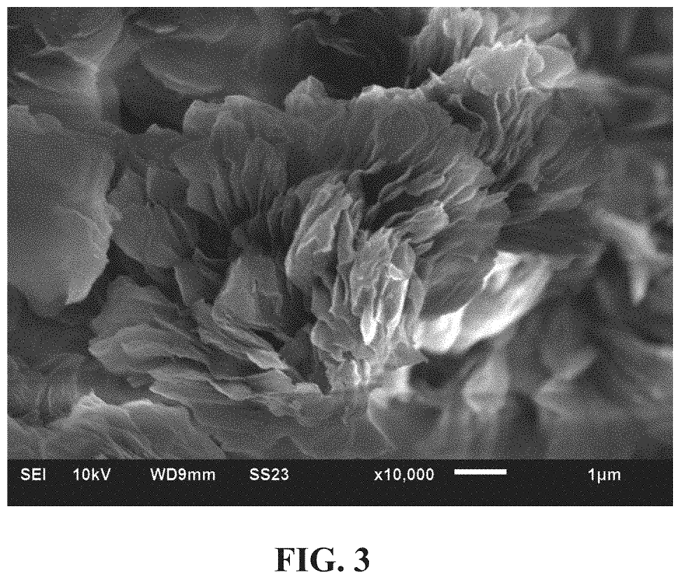

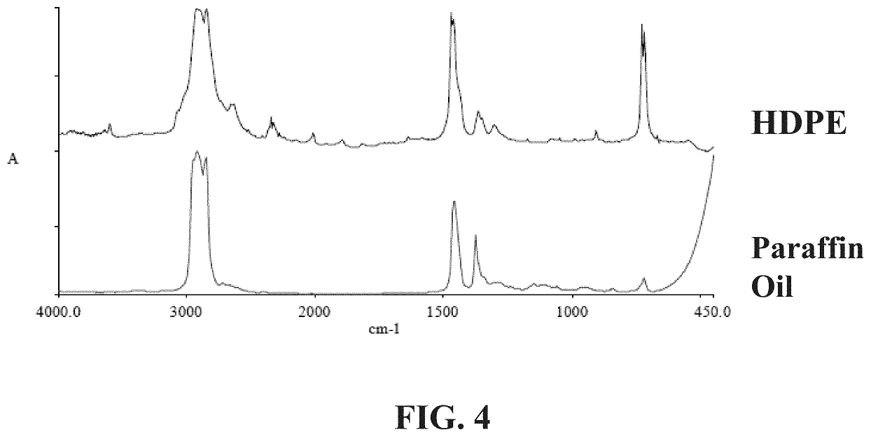

Reference is now made to FIG. 3, which depicts a SEM image of an HDPE polymer composition obtained by method 200 according to some embodiments of the invention. Nano-lamellar structures and/or superstructures may include any known geometrical configuration of a combination of more than two lamellae (such as spherulites, sheaf structures, axialites), and/or any undefined form of structures to those skilled in the art. Structures without any amorphous material around them are displayed in FIG. 3. The nano-lamellae are intact and not damaged. The polymer nano-lamellae may have a thickness in nanoscale, e.g., from about 1 nm to about 1000 nm, more preferably from about 2 nm to about 50 nm. Nano-lamellae's ordered super-structure may be observed in the SEM image depicted in FIG. 4.

As used herein, “ordered structures and/or superstructures” refer to a recognizable pattern of at least one property, for example, a consistent arrangement (e.g., periodic arrangement) or directional orientation (e.g., all structures oriented in the same direction) in components of the crystals' population (e.g., with deviation in the orientation of less than 10%), applying to essentially a majority of components in the crystals' population, or in repeating and/or alternating groups of the crystals' population.

SEM analysis may be performed by any technique known in the art, such as, but not limited to, a SEM JEOL 6510LV instrument, optionally and preferably equipped with a SE (secondary electron) detector, optionally and preferably having a resolution of 3 nm at 30 kV.

Further enhancement of the physical differences between the crystalline nano-lamellae and the amorphous phase may be achieved by mixing of the polymer melt with a chosen percentage (% w/w) to obtain desired end product properties of one or more additives having molecules that cannot crystallize under polymer crystallization conditions and that do not phase separate from the polymer melt. Additive(s) may increase the solvent permeability of only the melt (and not the polymer crystals), and as such, may facilitate the amorphous phase extraction. Since the additives molecules cannot crystallize, they remain only in the amorphous phase and may be extracted with the amorphous phase.

The additive molecules may not phase-separate from the polymer melt, due to their need to be physically compatible with the polymer melt molecules, mainly in terms of the degree of polarity of the additive molecules and the polymer melt, which may be optionally and preferably be achieved when the additive(s) have a similar or even almost identical chemical structure as the polymer melt, along with optionally and preferably having an additional property of not being able to crystallize under the polymer crystallization conditions.

As a non-limiting example, an additive according to some embodiments of the present invention, suitable, for example, with HDPE, is paraffin oil. Paraffin oil has similar, even almost identical chemical structure as HDPE, but is an amorphous viscous liquid and is very compatible with HDPE melt and consequently, may not phase separate from the HDPE melt. Paraffin oil and polymer melt comprising HDPE polymer have similar non-polar properties, in particular at conditions of mixing at polymer melt temperatures as carried out according to some embodiments of the present invention.

Materials characterization techniques for selecting suitable additives that may compatible with chosen polymer materials, according to some embodiments of the present invention, may be carried out by, e.g., providing spectral information of chemical groups in the additive molecules and in the polymer and comparing similarity of the groups in each of the two materials. Such materials characterization technique may be measuring and analyzing Fourier-Transformed Infrared (FTIR) spectra of the two materials—additive and polymer materials, and comparing main absorbances in the FTIR spectrum of the polymer and of the additive.

Reference is now made to FIG. 4, which depicts an overlaid comparison of FTIR spectra of HDPE polymer prepared according to Comparative Method in the present disclosure (upper spectrum) and of paraffin oil additive material (lower spectrum) utilized according to some embodiments of the present invention.

The spectrum of HDPE (FIG. 4, upper curve), exhibits strong absorbance at about 2855 cm⁻¹ and about 2928 cm⁻¹, which may be attributed to symmetric and antisymmetric stretching vibrations of methylene CH bonds; a strong and sharp absorbance at about 1450 cm⁻¹, which may be attributed to bending vibrations of the CH bonds and a strong absorbance at about 730 cm⁻¹, which may be due to rocking vibrations of HDPE CH₂ groups. Such absorbance may correspond with chemical structure of HDPE. Small absorbance at about 1368 cm⁻¹, may be due to deformation vibration of CH₃ groups [5]. Nevertheless, such absorbance may be considerably small in comparison with very strong and sharp absorbencies described above. As such, the amount of CH₃ branches may be very small, which may correspond with characteristic linear nature of HDPE chemical structure.

As may be further exhibited from FTIR spectrum of paraffin oil additive depicted in the lower curve in FIG. 4, similar main absorbance as seen above in the FTIR spectrum of HDPE, namely, strong absorbance at about 2855 cm⁻¹ and about 2928 cm⁻¹, at about 1450 cm⁻¹, at about 730 cm⁻¹, and at about 1368 cm⁻¹. This indicates chemical similarity of the additive with the HDPE polymer. Nevertheless, CH₃ absorbance at about 1370 cm⁻¹, is much stronger than in the HDPE, indicating a much higher degree of branching in the paraffin oil molecules than in HDPE. Also, CH₂ rocking vibration at about 730 cm⁻¹, may be considerably smaller in the paraffin oil spectrum than in the HDPE spectrum. Such absorbance size may correspond with a much higher degree of branching of the paraffin oil, and when combined with the much lower molecular weight of the paraffin oil, may be responsible for the amorphous nature of the additive.

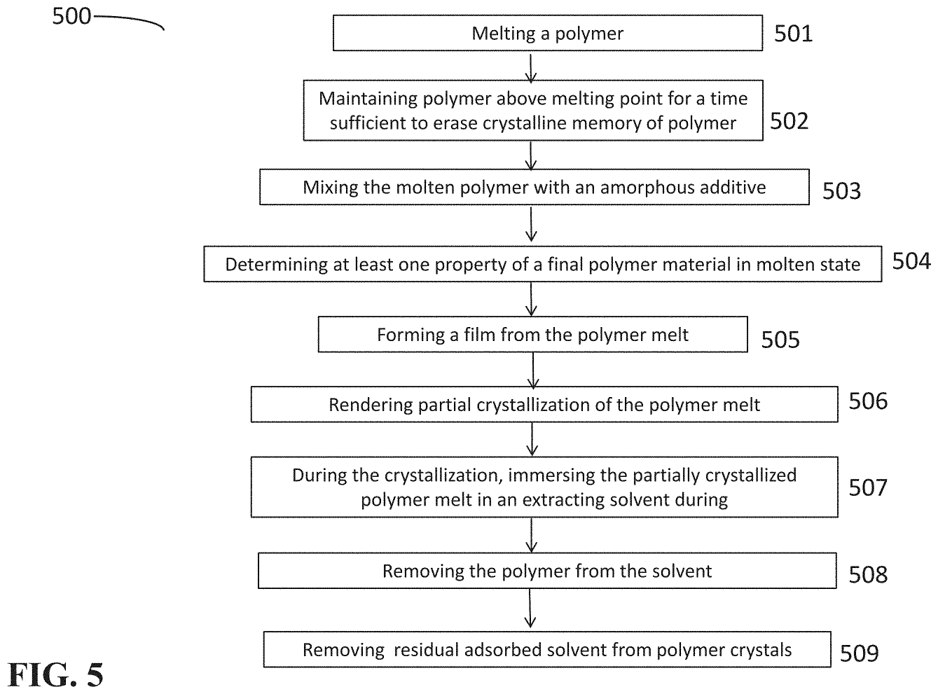

FIG. 5 is a flowchart diagram of a method suitable for preparing a crystalline polymeric composition, in embodiments of the invention in which one or more additives is utilized. The method is referred to herein as method 500.

At 501, a measured amount of a semi-crystalline polymer is melted, e.g., on a slide (e.g., a glass slide) by using a controlled-temperature heating plate, preferably at above melting temperature. At 502 the polymer is optionally and preferably maintained above its melting point for a time sufficient to erase crystalline memory of the polymer. For example, when HDPE polymer is utilized, the polymer melt can be heated to a temperature of 150° C. and maintained above this temperature for, e.g., 1-5 min, preferably, 1-4 min, more preferably, 2-4 min.

At 503 the polymer melt is mixed with a predetermined percentage (e.g., from about 1% to about 40% w/w) of one or more additives, for example, an amorphous additive, which comprises molecules that cannot crystallize under polymer crystallization conditions and that does not phase separate from the polymer melt. The additive(s) may increase solvent permeability of only the melt and as such may facilitate amorphous phase extraction. Since the additives molecules cannot crystallize, they remain only in the amorphous phase and are extracted with it.

Some non-limiting examples of additive materials suitable according to some embodiments of the present invention include low-molecular-weight synthetic polymers, low-molecular-weight natural polymers, fractioned polymers, branched polymers, dendrimers, essential oils, paraffin oils, oligomers, oils, non-volatile organic compounds, non-volatile solvents, surfactants, detergents, slip agents, organic dyes, plasticizers, phthalates wetting agents and combinations thereof. At times, the at least one amorphous additive material is, and/or comprises at least one of a surfactant and/or a wetting agent, for enhancing compatibility between additive and the polymer melt and/or the compatibility between the polymer melt and the solvent, thus also increasing solvent permeability in the melt.

At 504 at least one property selected from: size, shape and thickness of the final polymeric product is optionally and preferably determined, e.g., by industrial processing method. These may be chosen according to the desired final product properties, and desired process efficiency. At 505 the polymer melt is shaped, e.g., manually, to form a film on a slide (e.g., glass slide). This can be done, for example, by utilizing a cylindrical rod (e.g., glass rod) placed on a heating source.

In some embodiments, the method comprises heating the molten polymer while mixing with a sufficient amount of one or more amorphous materials to obtain a homogeneous slurry before the cooling. In these embodiments, the method can optionally apply a layer of the homogeneous slurry on a surface of a support.

At 506 the glass slide supporting the polymer melt may be removed from the heating source to allow partial crystallization of the polymer melt. This can be done under any conditions suitable for crystallization, e.g., by air-cooling at room temperature (about 30° C.). In some embodiments of the present invention the cooling may be carried out at an isothermal temperature, which depends on the desired polymer type and desired product quality, as a certain temperature below which isothermal crystallization may not possible only by continuous cooling.

For HDPE (as a non-limiting example only) the isothermal crystallization temperature range may be from about 130° C. to about 120° C. The crystallization temperature range depends on the polymer type, quality, manufacture, etc.

Similarly to method 200 above, the parameters crystallization start time, crystallization end time, and crystallization kinetics period, are also used, and optionally and preferably measures separately or received as input.

At a chosen time during the crystallization kinetics period the partially crystallized polymer melt may be immersed 507 (optionally and preferably with the slide) in a suitable extracting solvent as further detailed hereinabove, optionally and preferably, under mild manual agitation, for a chosen period of time, for example, from about 1 second to about 300 seconds, preferably from about 10 second to about 100 seconds, more preferably from about 20 seconds to about 40 seconds. In some exemplary experiments, the solvent may be cooled to a temperature of below room temperature, for example, in an ice-water bath, prior to the removing polymer from solvent (extracting) process, so as to enhance the solvent's selectivity towards only the polymer melt. At 508 the polymer crystals and optionally and preferably also the slide, is removed from the extracting solvent.

Immersing the polymer crystals and the molten polymer in a solvent may be executed at a time of between about 0.01 tk and about 0.99 tk after said crystallization initiating, depending on the polymer type, quality, manufacture, etc. In some embodiments, the immersing is executed after at least about 0.01% of the molten polymer becomes crystals.

At 509, residual adsorbed solvent may be removed from the obtained polymer crystals, e.g., by immediately contacting the polymer crystals (for example, within less than 5 seconds) with a drying device as further detailed hereinabove.

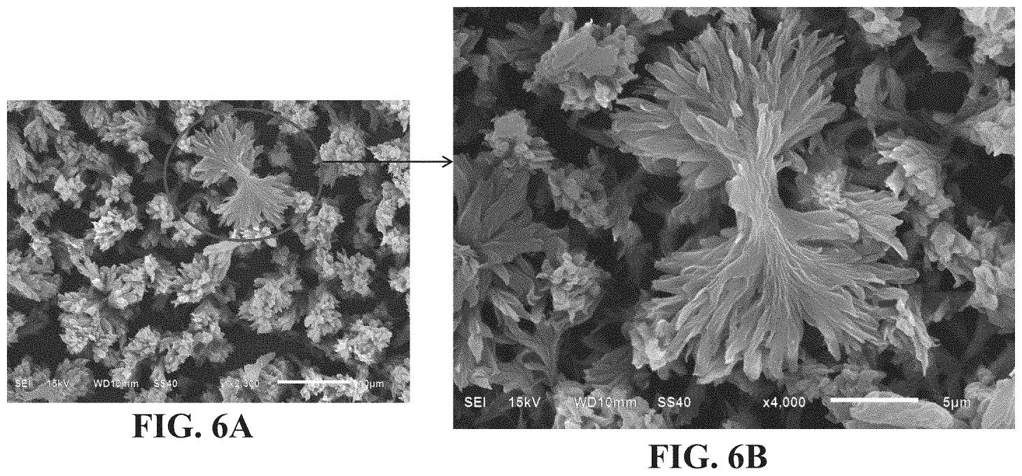

Reference is now made to FIGS. 6A and 6B, depicting Scanning Electron Microscopy (SEM) images of an HDPE polymer composition obtained by method 500. Shown are SEM images at magnifications of ×2,300 (FIG. 6A) and ×4,000 (FIG. 6B). FIGS. 6A-6B demonstrate that the amorphous material may be completely removed by using method 500, such that essentially no trace of the amorphous phase may be observed in the samples by SEM. SEM analysis may be performed by a SEM instrument as described above.

The inventor has found that a majority or even all of the lamellar structures in the polymeric composition according to some embodiments of the present invention may be oriented in generally the same direction (with tolerance of ±5°), for example, in a vertical direction with respect to the substrate plane and/or the substructures beneath the lamellar structures.

In some exemplary embodiments of the invention, the lamellar structures may be organized in a sheaf structure. For example, FIG. 6B shows a sheaf structure in a single super-structure on the sample surface, oriented at 90° to the same structures beneath it (e.g., in parallel to the substrate plane).

Obtaining a consistent ordered preferential orientation of the lamellar super-structures, is useful in many nanotechnology applications. The preferential orientation may be controlled and/or affected by various parameters such as processing methods, application of external or internal forces, materials composition, impurities content and presence of substrate. Other parameters may be natural or induced self-assembly during the crystallization process. Following are additional properties of the composition according to some embodiments of the present invention, e.g., a composition obtained by one of the above methods.

The composition according to some embodiments of the present invention may comprise a crystalline structure having a bundle of lamellar structures having a polymer and being devoid of trace of amorphous material, detectable by Scanning Electron Microscopy (SEM) with a magnification of ×2,300 at working distance of 10 mm and acceleration voltage of 15 kV.

The polymeric crystals morphology may also have individual lamellae, optionally and preferably, multi-lamellar and/or nano-lamellar structures, which may depend on the polymer type and crystallization conditions. For example, HDPE may crystallize in lamellae that are not in spherulitic structures when crystallized under isothermal crystallization conditions, and in spherulitic structures under continuous cooling crystallization conditions.

The lamellae and/or the lamellar super-structures may have any shape, structure, size, dimensions (length, width and/or thickness) and any spatial configuration; and may be completely clean of amorphous phase and/or self-standing. Additionally or alternatively, there may be essentially no damage to the lamellae and/or the lamellar superstructures, detectable by SEM with a magnification of ×2,300 at working distance of 10 mm and acceleration voltage of 15 kV. In some exemplary embodiments, the bundle of lamellae and/or lamellar structures has a structure selected from the group consisting of: a multi-lamellar structure, nano-lamellar structure, branched lamellae structure, branched multi-lamellar structure, twinned lamellar structure, spherulite structure, sheaf structure, axialite structure, dendritic spherulite structure, dendritic structure, interconnecting ordered lamellae structure, interconnecting disordered lamellae structure and any combination thereof.

In some of its embodiments, the present invention provides a composition comprising a polymeric crystalline structure having lamellae and/or multi-lamellar structures and/or bundles of lamellar structures, and being devoid of trace of amorphous material, wherein each of the lamellae and/or multi-lamellar structures is devoid of etched edges and/or broken lamellar regions and/or lamellar structures regions, detectable by SEM with a magnification of ×2,300 at working distance of 10 mm and acceleration voltage of 15 kV.

In some of its embodiments, the present invention provides a composition comprising a crystalline structure having a plurality of bundles of lamellar structures, preferably nanostructures, comprising a polymer, wherein a first side of the crystalline structure engages a substrate and a second side of the crystalline structure is free, wherein inter-bundle voids at the second side, over an area of about 10 square μm and thickness of about 1 μm, have an average diameter of at least 1 μm, and are devoid of any amorphous material. For example, FIGS. 6A-6B shows a plurality of lamellar structures wherein inter-bundle voids at the second side, over an area of about 10 square μm and thickness of about 1 μm, has an average diameter of at least 1 μm, and is devoid of any amorphous material.

In some of its embodiments, the present invention provides a composition comprising a polymeric crystalline structure having a plurality of lamellae and/or multi-lamellar and/or nano-lamellar structures comprising a polymer, wherein a first side of the crystalline structure engages a substrate and a second side of the crystalline structure is free, wherein inter-lamellar and/or inter-multi-lamellar inter-nano-lamellar voids at the second side, over an area of about 10 square μm and thickness of at least 1 μm, have an average (equivalent) diameter of at least 0.01 μm, and are devoid of any amorphous material. Namely, by removal of amorphous phase, voids (inter-lamellar gaps) having said average diameter of at least 0.01 μm are provided.

Additionally or alternatively, the structures may be essentially devoid of inter-lamellar amorphous material, namely, the polymeric composition may comprise inter-lamellar voids (gaps) having essentially no trace of amorphous material between the voids. In such embodiments, the inter-lamellar gaps may have a diameter between about 0.01 μm and about 1,000 μm, and/or between about 0.01 μm and about 500 μm, and/or between about 0.01 μm and about 100 μm.

In some embodiments, the inter-bundle voids at the second side, over an area of about 10 square μm and thickness of about 1 μm, have an average diameter of at least about 0.1 μm, preferably at least about 0.01 μm, and may additionally be devoid of any amorphous material. Optionally, at least two of the voids are interconnected. Same or equivalent voids may also occur when a substrate is not used.

In some embodiments, the composition has a surface region of at least one lamella, separate from the bundle and/or in the bundle of lamellar structures is devoid of amorphous material. In some embodiments, for at least 5 or at least 10 or at least 20 or at least 30 or at least 40 of the lamellae, at least 40% or at least 35% or at least 30% or at least 25% of the surface region of said lamellae is devoid of amorphous material.

In some embodiments, the composition wherein at least 25% of each of at least 10 of said lamellae, have a surface region that is devoid of amorphous material.

Each of the lamellae typically have two opposing surfaces referred to as a first surface and a second surface, wherein the thickness of the respective lamella is defined as the distance between these surfaces generally perpendicular thereto. In some embodiments of the present invention, for at least 5 of the lamellae the average of the thickness is smaller than an average width of the two surfaces. The two opposing surfaces may be in nano-scale. For example, the width of the first surface may be from about 100 nm to about 100,000 nm (100 μm), preferably from about 2,000 nm to about 50,000 nm (50 μm), and the width of the second surface may be essentially similar. In some embodiments, the average thickness of the respective lamella (the average distance between the first and second surfaces) is less than 1 μm, preferably less than 0.1 μm.

The inventor has found that according to the desired polymer type and/or crystallization conditions, the lamella's average length that may be approximately equal (e.g., with deviation of less than 10%) to lamella's average width. The lamellae and/or the lamellar structures may in some cases comprise quantum dots and/or may be unidimensional or zero-dimensional.

In some of its embodiments, the present invention provides a composition comprising a crystalline structure having a first plurality of bundles of lamellar structures, preferably nanostructures, comprising a polymer arranged on a substrate generally perpendicular thereto, and at least one additional bundle of lamellar structures (super-structure) generally parallel to the substrate and being on top of lamellar structures of the first plurality and/or sequences and/or multiple layers thereof. For example, with reference to FIGS. 6A and 6B, a super-structure on top of lamellar structures is encircled in FIG. 6A and is displayed in a higher magnification in FIG. 6B.

In some embodiments of the present invention each of the structures may be separated at a pre-selected distance from each other to form a network of crystalline platelets. The inter-structures distance may optionally and preferably be uniform. Optionally, the structures may be generally parallel to each other and vertically oriented on the surface of the polymeric composition sample to form a bundle or array of structures, extending over nano-size regions of a polymer sample, and optionally even over micron-size areas. The inter-lamellar distance between neighboring lamellae (individual or as part of a multi-lamellar structure) may be any distance, including zero (when neighboring lamellae touch in at least one point).

In some embodiments, the composition comprising lamellae and/or lamellar structures having neighboring lamellae associated in at least one point, e.g., neighboring lamellae are connected in at least one mutual point on each of the lamellae's surface.

In some embodiments, the substrate and the crystalline structure comprise the same polymer. In some embodiments, the composition comprises a foreign material that is generally different from the polymeric material, e.g., a conductive material, a semiconductive material, an insulating material, a metal, metal alloys, a metal oxide, a material containing a salt, a material containing a catalyst, a material containing a drug, a material containing an enzyme, a doped material, an optically active material, a biofilm, a gel, a sol-gel, a polymer, a glass, a ceramic material, a biological-derived material, an adhesive, a textile, a fibrous material, a nanomaterial, and/or combinations thereof. The foreign material can fill or partially fill one or more voids between two or more lamellae or bundles of lamellar structures. Alternatively or additionally, the foreign material can coat or partially coat the surfaces of the lamellae.

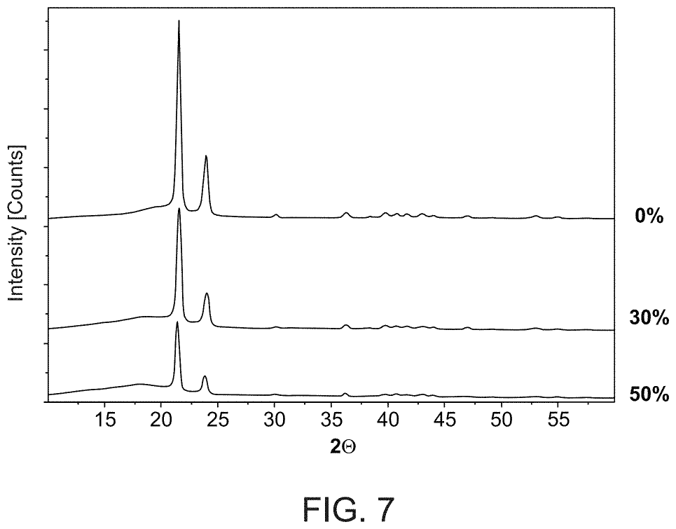

Reference is now made to FIG. 7 illustration a comparison of X-Ray Diffraction (XRD) graphs of exemplary polymers, according to some embodiments of the present invention, in which 0% w/w (upper graph), 30% w/w (middle graph) and 50% w/w (lower graph) paraffin oil serving as an additive was utilized (i.e., 50% w/w additive and 50% w/w HDPE).

The upper XRD graph represents an orthorhombic diffraction pattern of pure HDPE polymer [3-4]. The two lower graphs representing HDPE with increasing contents of the additive (paraffin oil in this example), exhibit the same XRD diffraction pattern as the pure polymer. The difference between the XRD diffraction patterns is a gradual decrease in ratio between the crystalline diffraction peaks integration and that of the diffuse scattering derived from amorphous material. As such, the method according to some embodiments of the invention, does not affect the crystal structure of the polymer, in the present case, orthorhombic crystal structure of HDPE, but only affects the degree (percent) of crystallinity of the polymer. In some embodiments, the degree of crystallinity of the polymeric composition is in the range of from about 1% to about 99.9%, or at times from about 20% to about 99.5%, from about 80% to about 99.5%. In some embodiments, the degree of crystallinity of the polymeric composition is at least about 1%, or at least about 5%, or at least about 10%, or at least about 30%, or at least about 40%, or at least about 60%, or at least about 70%, or at least about 80%, or at least about 90%, or at least about 92%, or at least about 94%, or at least about 95%, or at least about 96%, or at least about 97%, or at least about 98%, or at least about 99%, or even at times, at least about 99.5%.

In some of its embodiments, the present invention provides a composition serving as a component in an object selected from: a microelectronic device, a space replica, an artificial implant, an artificial tissue, a controlled delivery system, a medicament, a biofilm, a membrane, a filter, a chromatography column, a catalyst, a nano-scaffold, a micro-robot component, a micro/nano-machine component, a computer component, an optical device, a molecular sieve, a detector, a high-specific-surface article, an adsorbing material, a substrate, a nucleant and a nano-reactor component.

In some embodiments, the composition serving as a component is a microelectronic device, and/or a space replica, and/or an artificial implant, and/or an artificial tissue, and/or a controlled delivery system, and/or a medicament, and/or a biofilm, and/or a membrane, and/or a filter, and/or a chromatography column, and/or a catalyst, and/or a nano-scaffold, and/or a micro-robot component, and/or a micro/nano-machine component, and/or a computer component, and/or an optical device, and/or a molecular sieve, and/or a detector, and/or a high-specific-surface article, and/or an adsorbing material, and/or a substrate, and/or a nucleant and/or a nano-reactor component.

According to some embodiments of the present invention, there is provided a replica, and/or negative-space replica comprising and/or resembling the shape of the crystalline polymer material described herein. A replica, and/or negative-space replica may be formed by pouring a soft material on or in a shape or mold, after which a soft material is solidified and assumes a negative shape of the original shape or mold. Exemplary uses may be in dentistry industry, for making a negative replica of teeth, which may serve as a mold for manufacturing dentures.

According to some embodiments of the present invention, there is provided a polymeric article comprising the composition described herein in at least 1% of at least one of said polymeric article's dimensions selected from length, width, height, thickness, depth, diameter, radius, weight, volume and surface area.

According to some embodiments of the present invention, there is provided a crystalline polymer material manufactured by the method described herein.

Yet further, according to some embodiments of the present invention, there is provided use of the amorphous material extracted according to the methods described herein for producing any of: a lubricant; a slip agent; a plasticizer; a pharmaceutical excipient; a wetting agent; a surfactant; an additive; an adhesive material; a material with mild mechanical and thermal properties; a food additive; a reagent; a coating; a carrier for pigments; a carrier for active molecules; a surgical injectable material; a thickening agent; a diluting agent; a solvent; a fuel component; a cosmetic ingredient and a gel.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, nano-technology, materials science, pharmacological, biological, biochemical and medical arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### Materials and Experimental Methods

Materials List

| Material | Exemplary Provider |
|---|---|
| HDPE | DuPont, Sclair 2909 |
| Paraffin oil | USP grade, Merck |
| Xylene | Analytical grade, Frutarom |

### Preparation of HDPE Comparative Sample (Comparative Example 1)

1. A measured amount of 100 mg High-Density-Polyethylene (HDPE) polymer was melted on a clean glass slide, by placing it on a controlled-temperature heating plate, and kept at above its melting temperature (above about 132° C.) and kept at above 150° C. for 2 minutes in order to erase crystalline memory.

2. The HDPE polymer melt was manually shaped in a form of a film on the glass slide, by using a cylindrical glass-rod, on the heating source.

3. The glass slide supporting the HDPE polymer melt was removed from the heating source and complete crystallization of the polymer melt was performed by air-cooling at room temperature (about 30° C.). The thickness of the film obtained was approximately 20-25 μm.

4. The HDPE polymer film according to Comparative Example 1 was analyzed by SEM, XRD and FTIR.

Producing Crystalline Polymeric Samples

Preparation of Crystalline Polymeric Composition (Example 2)

1. A measured amount of 100 mg High-Density-Polyethylene (HDPE) polymer was melted on a clean glass slide, by placing it on a controlled-temperature heating plate, and kept at above its melting temperature (above about 132° C.) and kept at above 150° C. for 2 minutes in order to erase crystalline memory.

2. The polymer melt was manually shaped in a form of a film on the glass slide, by using a cylindrical glass-rod, on the heating source.

3. The glass slide supporting the HDPE polymer melt was removed from the heating source and partial crystallization of the polymer melt was performed by air-cooling at room temperature (about 30° C.). The crystallization process having a crystallization start time characterized by a time at which a first polymer crystal is formed (or nucleated) in the polymer melt; a crystallization end time characterized by a time at which a last polymer crystal stops growing in the melt and no additional crystals are formed; and a crystallization kinetics period therebetween. Immersion of the crystallizing polymeric material into an extracting solvent is initiated at any time during crystallization (before crystallization end time). HDPE polymer melt is transparent, whereas crystalline HDPE is opaque/translucent. Partial crystallization was achieved by optical (visual) monitoring the decrease in transparency of the HDPE melt during the crystallization process and initiating of extraction process at a chosen instant of the partial crystallization process.

4. The partially crystallized polymer melt was instantly immersed (along with the glass slide) in a suitable solvent (Xylene—Analytical, Frutarom), under mild manual agitation, for a chosen period of time (about 20-40 seconds) to obtain desired end product properties, and in accordance with the materials type and processing parameters (such as solvent type and temperature) sample size and shape. In this specific example, a relatively short immersion time was exercised as a precaution to ensure that crystalline lamellae are not affected by the solvent. As may be seen in the SEM images depicted in FIG. 3, the lamellae are perfectly clean and intact. A distinct additional advantage of using short immersion times is that it enables high efficacy of continuous industrial processing procedures. The solvent was cooled in an ice-water bath prior to the process to enhance its selectivity towards only the polymer melt.

5. The polymer sample along with the glass slide, was removed from the extracting solvent.

6. The polymer crystals were immediately contacted with several dry blotting papers repeatedly until the sample was completely dry, to prevent extracted polymer reprecipitation from the solvent that may adhere to the sample.

### Preparation of Crystalline Polymeric Composition (Example 3)

1. A measured amount of 100 mg High-Density-Polyethylene (HDPE) polymer was melted on a clean glass slide, by placing it on a controlled-temperature heating plate, and kept at above its melting temperature (above about 132° C.) and kept at above 150° C. for 2 minutes in order to erase crystalline memory.

2. The molten HDPE polymer sample was homogeneously mixed manually (using two small-diameter glass rods), on the glass slide and kept on the heating source, with a calculated percentage of an amorphous additive (about 20% w/w of Paraffin Oil—USP, Merck).

3. The polymer melt was manually shaped in a form of a film on the glass slide, by using a cylindrical glass-rod, on the heating source.

4. The glass slide supporting the HDPE polymer melt was removed from the heating source and partial crystallization of the polymer melt was performed by air-cooling at room temperature (about 30° C.). The crystallization process having a crystallization start time; a crystallization end time; and a crystallization kinetics period therebetween, similar to the crystallization process described in Example 1 above. The HDPE polymer melt is transparent, whereas the crystalline HDPE is opaque/translucent. Thus, partial crystallization was achieved by optical (visual) monitoring the decrease in transparency of the HDPE melt during the crystallization process and starting the extraction process at a chosen instant of the partial crystallization process.

5. The partially crystallized polymer melt was instantly immersed, along with the glass slide, in a suitable solvent (Xylene—Analytical, Frutarom), under mild manual agitation, for a period of time of 20-40 seconds. The solvent was cooled in an ice-water bath prior to the process to enhance its selectivity towards only the polymer melt.

6. The polymer, along with the glass slide, was removed from the extracting solvent.

7. The polymer was immediately contacted with several dry blotting papers, repeatedly, until the sample was completely dry. This step is important in order to prevent extracted polymer reprecipitation from the solvent that adheres to the sample.

Polymer Properties Measurements

Scanning Electron Microscopy (SEM) measurements were performed on a SEM JEOL 6510LV instrument, equipped with a SE (secondary electron) detector, with a resolution of 3 nm at 30 kV. The acceleration voltage was 10 kV. The polymer samples were viewed with Au sputter coating.

Fourier-Transformed Infrared Spectroscopy (FTIR) measurements were carried out on a Perkin Elmer-Spectrum BX FTIR Spectrometer. Solid polymer samples were prepared as films, from the polymer melt, crystallized by air-cooling at room-temperature and placed in the path of the instrument beam. Liquid additive samples were measured by applying an adequate amount of the material to a NaCl crystal window, which was placed in the path of the instrument beam. 16 scans were performed in each measurement. All spectra were measured in absorbance mode.

X-ray Diffraction (XRD) measurements were performed on a Panalytical X'Pert Pro diffractometer with Cu K\acute{α} radiation (λ=0.154 nm). Full pattern identification made by X′Pert HighScore Plus software package, version 2.2e (2.2.5) by Panalytical B.V. Phase analysis identification made by XRD, 40 kV, 40 mA. The XRD patterns were recorded in the 2Θ range of 5-50° (step size 00.2°; time per step 2s).

Results

FIGS. 1A-1B exhibit Scanning Electron Microscopy (SEM) images of the HDPE film obtained by the above procedure according to Comparative Example 1 at magnifications of ×800 and ×2,700, respectively. Amorphous non-crystallizeable material is visible in the SEM images displayed in FIGS. 1A-1B. Rhythmic changes in surface topography, is an indication of crystalline morphology within the amorphous phase, which is not only on the surface, but also throughout material enveloping all crystalline lamellae. In FIGS. 1A-1B, the surface is scratched in contact with mineral dust particles during sample handling.

As both crystalline nano-lamellae and interpenetrating amorphous phase are composed of the same polymer, the very slight physical differences between them do not enable significant selective removal of the amorphous phase, without also significantly destroying the nano-lamellar super-structures.

FIG. 3 depicts a Scanning Electron Microscopy (SEM) image of an HDPE polymer composition according to some embodiments of the invention, referred to as Example 2. As can be seen from FIG. 3, nano-lamellar super-structures without any amorphous material around them are displayed, and the nano-lamellae are intact and not damaged. The polymer nano-lamellae have a thickness in nanoscale, e.g., between about 10-100 nm, and nano-lamellae's ordered super-structures are observed in the SEM image depicted in FIG. 3. SEM analysis was performed by a SEM JEOL 6510LV instrument, equipped with a SE (secondary electron) detector, optionally and preferably having a resolution of 3 nm at 30 kV. The polymer samples were viewed with Au sputter coating.

FIGS. 6A-6B depict SEM images of an HDPE polymer composition obtained by method 3 according to some embodiments of the invention, at magnifications of ×2,300 and ×4,000, respectively, and referred to herein as Example 3. FIGS. 6A-6B display that the amorphous material was completely removed by using the method depicted in FIG. 5, such that no trace of the amorphous phase was observed in the samples. SEM analysis was performed by the SEM instrument as similarly described for Example 2. The nano-lamellar super-structures were completely clean, self-standing and the entire lamellar shape, structure, size and spatial configuration are seen in FIGS. 6A-6B, with no presence of any amorphous material. Also, by using this method, absolutely no damage occurred to the nano-lamellar super-structures, even the very delicate lamellar tips are perfectly intact.

The dark background in FIG. 6A is actually the glass substrate on which the samples were inserted into the SEM.

It should be noted that typically all the nano-lamellar super-structures in the sample are oriented in essentially the same direction (the vertical direction to the plane of the substrate, in the present Example). A consistent ordered preferential orientation of the nano-lamellar super-structures was obtained, namely, the majority of the lamellae or the lamellar structures are oriented in approximately the same direction with respect to a certain reference point or surface or location (anisotropic material), in contrast to random or isotropic orientation.

The nano-lamellar super-structures are organized in a sheaf structure. The sheaf structure can be clearly seen in a single structure on the sample surface, oriented at 90° to the same structures beneath (parallel to the substrate, in the present Example).

It is seen in FIG. 6B that essentially no amorphous material is present. The nano-lamellae are perfectly clean and self-standing.

FIG. 4, which depicts an overlaid comparison of FTIR spectra of HDPE polymer prepared according to Comparative Method (upper spectrum) and of paraffin oil additive material (lower spectrum) utilized according to some embodiments of the present invention.

The spectrum of HDPE (FIG. 4, upper curve), exhibits strong absorbances at 2855 cm⁻¹ and 2928 cm⁻¹, which is attributed to symmetric and antisymmetric stretching vibrations of methylene CH bonds; a strong and sharp absorbance at 1450 cm⁻¹, which is attributed to bending vibrations of the CH bonds and a strong absorbance at 730 cm⁻¹, which is due to rocking vibrations of HDPE CH₂ groups. Such absorbances correspond to chemical structure of HDPE. Small absorbance at 1368 cm⁻¹, is due to deformation vibration of CH₃ groups [5]. Nevertheless, such absorbance is considerably small in comparison with very strong and sharp absorbencies described above. As such, the amount of CH₃ branches is very small, which may correspond with characteristic linear nature of HDPE chemical structure.

As further exhibited from FTIR spectrum of paraffin oil additive depicted in the lower curve in FIG. 4, similar main absorbances as seen above in the FTIR spectrum of HDPE, namely, strong absorbances at 2855 cm⁻¹ and 2928 cm⁻¹, at 1450 cm⁻¹, at 730 cm⁻¹, and at 1368 cm⁻¹. This indicates a very strong chemical similarity of the additive with the HDPE polymer. Nevertheless, CH₃ absorbance at around 1370 cm⁻¹, is much stronger than in the HDPE, denoting a much higher degree of branching in the paraffin oil molecules than in HDPE. Also, CH₂ rocking vibration at around 730 cm⁻¹, is considerably smaller in the paraffin oil spectrum than in the HDPE spectrum. Such absorbance size corresponds with a much higher degree of branching of the paraffin oil, and when combined with the much lower molecular weight of the paraffin oil, is responsible for the amorphous nature of the additive.

FIG. 7 exhibits a comparison of XRD graphs of exemplary polymers, according to some embodiments of the present invention, in which 0% w/w (upper graph), 30% w/w (middle graph) and 50% w/w (lower graph) additive was utilized (according to Example 3 described herein)

The XRD graphs represent from top to bottom, 0%, 30% and 50% additive (paraffin oil) content of the HDPE, respectively. The upper XRD graph, represents a state of the art orthorhombic diffraction pattern of pure HDPE polymer [3-4]. The two lower graphs, representing HDPE with increasing contents of additive, exhibit the same XRD diffraction pattern as the pure polymer. A difference results from a gradual decrease in ratio between the crystalline diffraction peaks integration and that of the diffuse scattering derived from amorphous material. As such, the method according to some embodiments of the invention, does not affect the crystal structure of the polymer, in the present case, orthorhombic crystal structure of HDPE, but only affects the degree (percent %) of crystallinity of the polymer.

### REFERENCES

[1] Bower, D. I., Introduction to Polymer Physics, Cambridge University Press, 2008.
[2] Muhukumar, M., Shifting Paradigms in Polymer Crystallization, Lect. Notes Phys., 714: 1-18, 2007.
[3] Stern T., Wachtel E. and Marom G., Origin, Morphology and Crystallography of Transcrystallinity in Polyethylene-Based Single Polymer Composites, Composites, Part A, 28A: 437-444, 1997.
[4] Stern T., Wachtel E. and Marom G., Epitaxy and Lamellar Twisting in Transcrystalline Polyethylene, Journal of Polymer Science, Part B: Polymer Physics, 35: 2429-2433, 1997.
[5] Stern T., Synthesis and Characterization of Di-Polyester-Diamides, Journal of Applied

Polymer Science, 126 (1): 216-225, 2012.
[6] Sasaki, S., Sakaki, Y., Takahara, A. and Kajiyama, T., Microscopic Lamellar Organization in High-Density-Polyethylene Banded Spherulites Studied by Scanning Probe Microscopy, Polymer, 43: 3441-3446, 2002.
[7] Huang, L., Yang, W., Yang, B., Yang, M., Zheng, G. and An H., Banded Spherulites of HDPE Molded by Gas-Assisted and Conventional Injection Molding, Polymer, 49: 4051-4056, 2008.
[8] Basset, D. C. and Hodge, A. M., On Lamellar Organization in Banded Spherulites of Polyethylene, Polymer, 19: 469, 1978.
[9] Garter, G., Hill, A. E. and Nobes, M. J., Vacuum, 29: 213, 1979.
[10] Padhye, M. R., Bhat, N. V. and Mittal, P. K., Text. Res. J., 46: 502, 1976.
[11] White, H., PU, Y., Rafailovich, M., Sokolov, J., King, A. H., Giannuzzi, L. A., Urbanik-Shannon, C., Kampshall, B. W., Eisenberg, A., Schwarz, S. A., and Strzhemechny, Polymer, 42: 1613, 2001.
[12] Loos, L., van Duren, J. K. J., Morrissey, F. and Janssen, R. A. J., Polymer, 43: 7493, 2002.

1. A composition comprising, a polymeric crystalline structure having lamellae and/or multilamellar structures and being devoid of trace of amorphous material, detectable by Scanning Electron Microscopy (SEM) with a magnification of ×2,300 at working distance of 10 mm and acceleration voltage of 15 kV.

2. (canceled)

3. The composition of claim 1, wherein each of said lamellae and/or multilamellar structures is devoid of etched edges detectable by said SEM with said magnification at said working distance and said acceleration voltage of 15 kV.

4-6. (canceled)

7. The composition according to claim 1, wherein a first side of said crystalline structure engages a substrate and a second side of said crystalline structure is free,
wherein inter-lamellar or inter-multi-lamellar voids at said second side, over an area of about 10 square μm and thickness of at least 1 μm, have an average diameter of at least 0.01 μm, and are devoid of any amorphous material.

8. The composition according to claim 1, comprising a first plurality of bundles of lamellar nanostructures arranged on a substrate generally perpendicular thereto, and at least one additional bundle of lamellar nanostructure generally parallel to said substrate and being on top of lamellar nanostructures of said first plurality and/or sequences and/or multiple layers thereof.

9. The composition according to claim 7, wherein said substrate and said crystalline structure comprise the same polymer.

10. The composition according to claim 7, further comprising a foreign material that is generally different from the polymeric material, said foreign material at least partially filling at least one void between at least two lamellae or bundles of lamellar nanostructures or at least partially coating surfaces thereof.

11. (canceled)

12. The composition according to claim 1, wherein the bundle of lamellar structures has a structure selected from the group consisting of: a multi-lamellar structure, nano-lamellar structure, branched lamellae structure, branched multi-lamellar structure, twinned lamellar structure, spherulite structure, sheaf structure, axialite structure, dendritic spherulite structure, dendritic structure, interconnecting ordered lamellae structure, interconnecting disordered lamellae structure, epitaxial grown lamellae and any combination thereof.

13-42. (canceled)

43. The composition according to claim 1, wherein said polymer is part of a composite material.

44-46. (canceled)

47. A polymeric article comprising the composition according to claim 1 in at least 1% of at least one of said polymeric article's dimensions selected from length, width, height, thickness, depth, diameter, radius, weight, volume and surface area.

48. The composition according to claim 1, serving as a component in an object selected from: a microelectronic device, a space replica, an artificial implant, an artificial tissue, a controlled delivery system, a medicament, a biofilm, a membrane, a filter, a chromatography column, a size-exclusion column, an ion exchange column, a catalyst, a nano-scaffold, a micro-robot, a micro-machine, a nano-machine, a processor, an optical device, a molecular sieve, a detector, an adsorbing material, a substrate, a nucleant, a nano-reactor, a mechanical component, a friction coefficient reducer or enhancer, and a gecko foot simulator.

49-55. (canceled)

56. A method of producing a crystalline polymer material, the method comprising:
providing a molten polymer;
determining at least one property of a final polymer material in molten state selected from the group consisting of: size, shape and thickness;
initiating crystallization of polymer crystals in a molten polymer;
rendering growth of polymer crystals in said molten polymer;
during said crystallization, immersing said polymer crystals and said molten polymer in an extracting solvent;
removing said polymer from said solvent; and
removing residual adsorbed solvent from said polymer crystals after said removing polymer from solvent;
thereby producing a final crystalline polymer material that is essentially free of amorphous material.

57. A method of producing a crystalline polymer material, the method comprising:
initiating growth of polymer crystals from a molten polymer;
during said growth, immersing said polymer crystals and said molten polymer in an extracting solvent;
removing at least one polymer crystals from said solvent; and
removing residual adsorbed solvent from said polymer crystals;
thereby producing a final crystalline polymer material that is essentially free of amorphous material.

58. A method of producing a crystalline polymer material, the method comprising:
melting a polymer;
determining at least one property of a final polymer material in molten state selected from the group consisting of: size, shape and thickness;
initiating growth of polymer crystals in the molten polymer;
during said growth, immersing said polymer crystals and said molten polymer in a solvent, under chosen conditions selected from: solvent temperature, agitation and immersion time;
removing said immersed polymer crystals from the solvent; and
removing residual adsorbed solvent from said polymer crystals.

59. The method according to claim 58, wherein the immersing said polymer crystals and said molten polymer in a solvent is carried out at a solvent temperature of between −15° C. to 5° C. below solvent boiling point, agitation time of between 1 second to a time equal to the immersion time and immersion time of between 1 second to 600 seconds.

60-69. (canceled)

70. The method according to claim 56, further comprising any combination of continuous cooling and isothermal processes and/or consecutive repetition thereof, to provide said polymer crystals.

71. (canceled)

72. The method according to claim 56, wherein said crystallization is characterized by: a crystallization start time, defined as a time when a first polymer crystal is nucleated in the polymer melt; a crystallization end time, defined as characterized by a time when a last crystal stops growing in said melt and no additional crystals are formed; and a crystallization kinetics period tₖ, defined as a duration beginning at said crystallization start time and ending at said crystallization end time, and
wherein said immersing is executed at a time of between about 0.01 tₖ and about 0.99 tₖ after said crystallization start time.

73-77. (canceled)

78. The method according to claim 56, further comprising mixing the molten polymer with at least one amorphous additive material prior to said crystallization start time.

79. (canceled)

80. The method according to claim 56, further comprising mixing the molten polymer with at least one additive material that has at least one of the following properties:
it is amorphous;
it is liquid at melting temperature of the polymer;
it does not crystallize when in mixture with the polymer; and
it is not capable of phase-separating from the polymer melt prior to said immersing.

81-88. (canceled)

89. The method according to claim 56, further comprising heating said molten polymer while mixing with a sufficient amount of at least one amorphous material to obtain a homogeneous slurry before said cooling.

90. The method according to claim 89, further comprising applying on a surface of a support, a layer of said homogeneous slurry.

91-103. (canceled)
